(19) United States
(12) Patent Application Publication
(10) Pub. No.: US 2005/0007751 A1
(43) Pub. Date: Jan. 13, 2005

(54) Illuminated logo unit with light guide plate

(76) Inventor: Kun-Jung Tsai, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/889,887

(22) Filed: Jul. 12, 2004

(30) Foreign Application Priority Data
Jul. 11, 2003 (TW) 92119082

(51) Int. Cl. G01D 11/28

(52) U.S. Cl. 362/23

(57) ABSTRACT

An illuminated logo unit (300) includes an image panel (301), and an underlying illuminating device (310) transmitting light beams to the image panel. The illuminating device includes an inner discoid light guide plate (312) fitted into an outer annular light guide plate (311), and four light sources (369, 359) separately emitting light beams toward respective emitting surfaces (360, 350) of the light guide plates. A reflective film (362) coated on a circumferential wall (361) of the inner light guide plate prevents light beams in each light guide plate from interfering with light beams of the other light guide plate. A reflective film (352) coated on a circumferential wall (351) of the outer light guide plate prevents light beams from leaking thereout. By the use of the light guide plates, the illuminated logo unit attains uniform illumination in each of two illumination areas thereof.

### BACKGROUND OF THE INVENTION

1. Field of the Invention

The present invention relates to an illuminated logo unit, and particularly to an illuminated logo unit having uniform illumination in each of discrete illumination areas thereof.

2. Prior Art

A conventional logo unit, such as a registration mark on a billboard or an insignia on a vehicle, cannot illuminate itself. If the image of the logo unit is to be clearly seen at night, it must be illuminated by an external source. However, external illumination has various inherent limitations, including the angle of illumination, the brightness of the source, and the reflective ratio of the logo unit. These limitations frequently result in the logo unit being unevenly illuminated. Furthermore, the brightness and overall display of the logo unit may be unsatisfactory.

Generally, to solve the above-described problems, an active light source is arranged at the back of the logo unit. A logo unit having an active light source arranged at the back thereof is known as an illuminated logo unit.

A conventional illuminated logo unit 100 as disclosed in U.S. Pat. No. 6,174,075 is represented in FIG. 6. The unit 100 has a top surface 110, and a circumferential lip 132 which may be used to secure the unit 100 to a garment or another article such as a hat. The top surface 110 includes one or more graphic elements which form a predetermined design. The top surface 110 may be separated from the lip 132 by a cylindrical sidewall 131. The unit 100 is formed with a central cavity 135, which spans to a bottom surface (not labeled) of the unit 100. The cavity 135 is structured to receive a light source system 133, which transmits light beams to pass through the top surface 110. The light source system 133 has a point light source 137, and batteries 138 providing power to the point light source 137.

Because the point light source 137 is arranged corresponding to a center of the top surface 110, the distribution of light energy over the whole top surface 110 from the point light source 137 is uneven. For example, a central circular area on the top surface 110 receives much more light energy from the point light source 137 than other portions of the top surface 110. Accordingly, a brightness of the top surface 110 is not uniform. The result is that the entire top surface 110 cannot be clearly seen at night.

A new illuminated logo unit that overcomes the above-mentioned disadvantages is desired.

### SUMMARY OF THE INVENTION

An object of the present invention is to provide an illuminated logo unit with uniform illumination.

Another object of the present invention is to provide an illuminated logo unit with uniform illumination in each of discrete illumination areas thereof.

To achieve the above-mentioned objects, an illuminated logo unit of the present invention includes an image panel, and an underlying illuminating device transmitting light beams to the image panel. The illuminating device comprises at least two juxtaposed light guide plates and at least two corresponding light sources. The light sources separately emit light beams to the light guide plates respectively. Reflective films coated on peripheral walls of the light guide plates prevent light beams in each light guide plate from interfering with light beams of another adjacent light guide plate, and prevent light beams from leaking out through the peripheral wall of the outmost light guide plate. Reflective films coated on bottom surfaces of the light guide plates reflect light beams from the respective light sources in directions toward respective emitting surfaces of the light guide plates. All the reflective films concentrate light beams from the respective light sources toward the respective emitting surfaces. By the use of the light guide plates, the illuminated logo unit attains uniform illumination in each of illumination areas thereof.

Other objects, advantages and novel features of the invention will become more apparent from the following detailed description when taken in conjunction with the accompanying drawings; in which:

### BRIEF DESCRIPTION OF THE DRAWINGS

FIG. 1 is an exploded, perspective view of an illuminated logo unit in accordance with a first embodiment of the present invention;

FIG. 2 is an exploded perspective view of an illuminating device of the illuminated logo unit of FIG. 1, but only showing two of four light sources thereof;

FIG. 3 is a top elevation of the illuminating device of FIG. 2 fully assembled;

FIG. 4 is an exploded, perspective view of an illuminated logo unit in accordance with a second embodiment of the present invention;

FIG. 5 is an exploded, isometric view of an illuminated logo unit in accordance with a third embodiment of the present invention; and

FIG. 6 is an exploded, schematic cross-sectional view of a conventional prior art illuminated logo unit.

### DETAILED DESCRIPTION OF THE PREFERRED EMBODIMENTS

Hereinafter, exemplary embodiments of the present invention will be explained in detail with reference to the accompanying drawings.

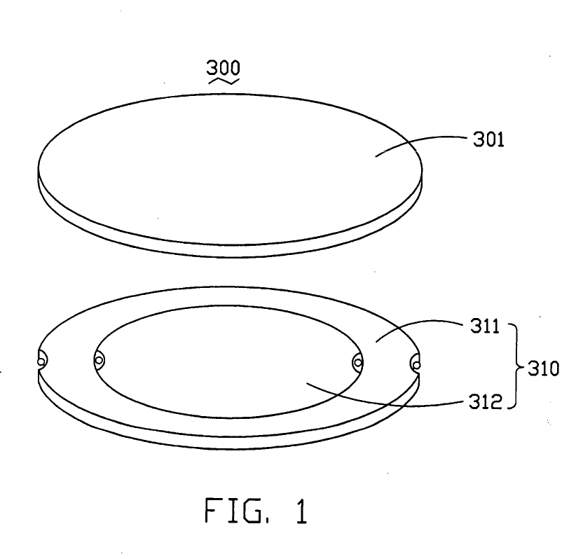

FIG. 1 is an exploded, perspective view of an illuminated logo unit 300 according to the first embodiment of the present invention. The illuminated logo unit 300 comprises an illuminating device 310, and an image panel 301 disposed on the illuminating device 310. The image panel 301 is preferably flexible or pliable, being made of a plastic material such as polyvinyl chloride (PVC). In this case, the image panel 301 is attached on the illuminating device 310. Alternatively, the image panel 301 can be made of a hard material, in which case it is fastened on the illuminating device 310 by a frame or a clip (not shown).

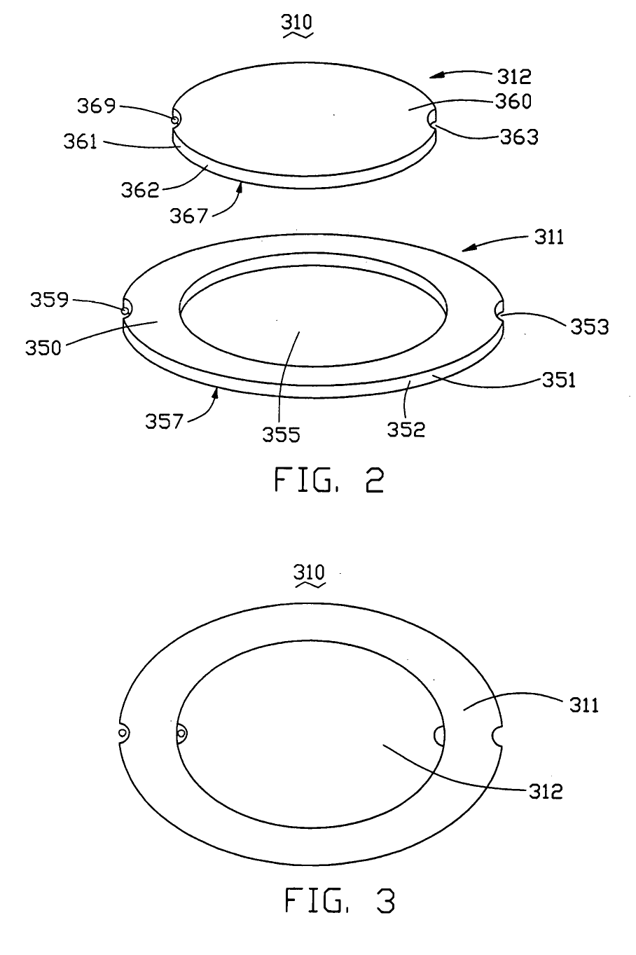

Referring to FIG. 2 and FIG. 3, the illuminating device 300 comprises an annular first light guide plate 311, a second light guide plate 312 matching with the first light guide plate 311, and a plurality of light sources 359, 369.

The first light guide plate 311 comprises a first emitting surface 350 for emitting light beams, a first circumferential sidewall 351 adjoining the first emitting surface 350, a first bottom surface 357 opposite to the first emitting surface 350, and a central hole 355. The first circumferential sidewall 351 defines two opposite grooves 353, and has a reflective film 352 attached thereon except at the grooves 353. The reflective film 352 prevents light beams from leaking out through the first circumferential sidewall 351. The grooves 353 respectively accommodate two light sources 359. The light sources 359 may be point light sources. Light beams emitted from the light sources 359 enter the first light guide plate 311 through respective incident surfaces (not labeled) at the grooves 353. The first bottom surface 357 has a plurality of dots (not shown) for diffusing light beams, and a reflective film (not shown) for reflecting light beams to the first emitting surface 350.

The second light guide plate 312 is fitted into the hole 355 of the first light guide plate 311, and comprises a second emitting surface 360, a second circumferential sidewall 361, and a second bottom surface 367 opposite to the second emitting surface 360. The second circumferential sidewall 361 defines two opposite grooves 363, and has a reflective film 362 attached thereon except at the grooves 363. The reflective film 362 prevents light beams from interfering with light beams of the first light guide plate 311. The grooves 363 respectively accommodate two light sources 369. The light sources 369 may be point light sources. Light beams emitted from the light sources 369 enter the second light guide plate 311 through respective incident surfaces (not labeled) at the grooves 363. The second bottom surface 367 has a plurality of dots (not shown) for diffusing light beams, and a reflective film (not shown) for reflecting light beams to the second emitting surface 350.

In operation, the second light guide plate 312 is accommodated in the hole 355 of the first light guide plate 311. The light sources 359, 369 separately emit light beams to the first light guide plate 311 and the second light guide plate 312 respectively. By the use of the reflective films 352, 362 and the reflective film (not labeled) on the first bottom surface 357, light beams from the light sources 359 are concentrated at the first emitting surface 350. The reflective film 352 prevents the light beams from leaking out from the first circumferential sidewall 351. The reflective film 362 prevents light beams from transmitting into the second light guide plate 312. The reflective film on the first bottom surface 357 reflects light beams from the light sources 359 in directions toward the first emitting surface 350. Furthermore, the dots on the first bottom surface 357 eliminate total internal reflection of light beams by diffusing the light beams thereat, thereby attaining uniform illumination over the whole first emitting surface 350.

In the second light guide plate 312, light beams from the light sources 369 are concentrated to the second emitting surface 360 by the use of the reflective film 362 on the second circumferential sidewall 361 and the reflective film (not labeled) on the second bottom surface 367. The reflective film 362 reflects light beams impinging on the second circumferential sidewall 361 back into the second light guide plate 312. This prevents the light beams from interfering with light beams of the first light guide plate 311. The reflective film on the second bottom surface 367 reflects light beams from the light sources 369 in directions toward the second emitting surface 360. Furthermore, the dots on the second bottom surface 367 eliminate total inner reflection of light beams by diffusing the light beams thereat, thereby attaining uniform illumination over the whole second emitting surface 360.

In summary, the illuminating device 310 defines two illumination areas according to the first and the second light guide plates 311, 312. By adjusting the colors and the illuminating intensities of the light sources 359, 369, the illuminating device 310 can have two different illumination areas with different colors and different illumination intensities.

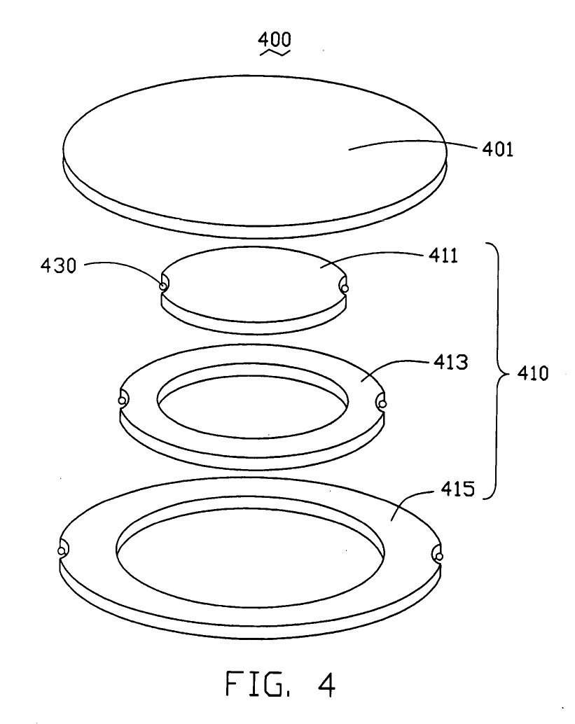

As shown in FIG. 4, an illuminated logo unit 400 in accordance with the second embodiment of the present invention has a structure similar to that of the illuminated logo unit 300 of the first embodiment. The illuminated logo unit 400 comprises an illuminating device 410 and an image panel 401. The illuminating device 410 has three light guide plates 411, 413, 415 matching with each other, and a plurality of light sources 430 emitting light beams to the three light guide plates 411, 413, 415 respectively. The light sources 430 may be point light sources. Each light guide plate 411, 413, 415 has a circumferential sidewall, with a reflection film coated on the circumferential sidewall. The light guide plates 411, 413, 415 are inlaid one to the other, thereby forming three illumination areas. By controlling the colors and illumination intensities of the light sources 430, the illuminated logo unit 400 can have three different colors and three different intensities in the three illumination areas.

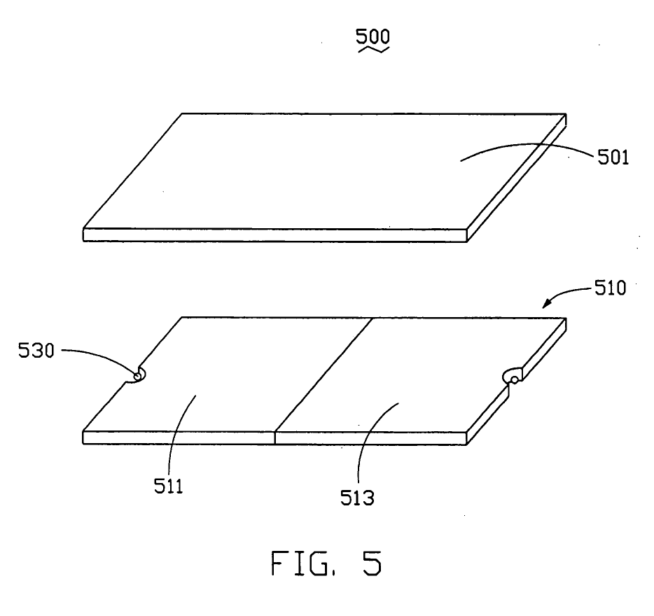

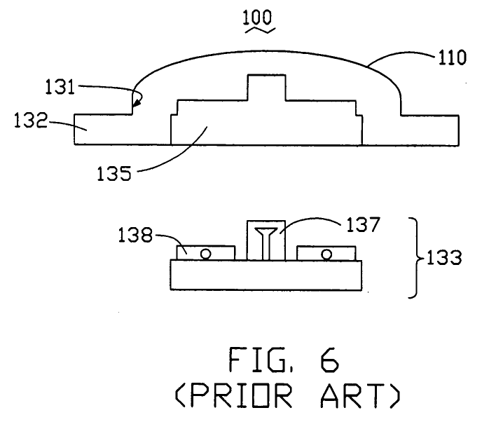

FIG. 5 is an exploded, isometric view of an illuminated logo unit 500 in accordance with the third embodiment of the present invention. The illuminated logo unit 500 is similar to the illuminated logo unit 300 of the first embodiment. The illuminated logo unit 500 has an image panel 501, and an illuminating device 510 transmitting light beams to the image panel 501. The illuminating device 510 includes two light guide plates 511, 513, and a plurality of light sources 530 cooperating with the light guide plates 511, 513, respectively. The light sources 530 may be point light sources. The light guide plate 511 is juxtaposed with the light guide plate 513 to form two juxtaposed illumination areas. A reflective film is provided between the light guide plates 511, 513, in order to prevent light beams in either light guide plate 511, 513 interfering with light beams of the other light guide plate 513, 511.

The shapes and numbers of the various light guide plates described can be varied according to need. Furthermore, and colors and illumination intensities of the various light sources described can be varied according to need. Thus a desired display that is clear can be obtained.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An illuminated logo unit, comprising:
an image panel; and
an illuminating device transmitting light beams to the image panel; wherein the illuminating device comprises a light source and a light guide plate transmitting light beams from the light source to the image panel.

2. The illuminated logo unit of claim 1, wherein the light guide plate comprises an emitting surface transmitting light beams to the image panel, and a peripheral sidewall adjoining the emitting surface.

3. The illuminated logo unit of claim 2, wherein the peripheral sidewall defines a groove accommodating the light source, wherein light beams are introduced into the light guide plate at the groove.

4. The illuminated logo unit of claim 3, wherein a reflective film is coated on the peripheral sidewall except at the groove.

5. The illuminated logo unit of claim 4, wherein the reflective film is made from a material having a high reflectivity.

6. The illuminated logo unit of claim 1, wherein the image panel is directly fixed on the illuminating device or is clipped on the illuminating device.

7. The illuminated logo unit of claim 1, wherein the light source is a point light source.

8. An illuminated logo unit, comprising:
an image panel; and
an illuminating device transmitting light beams to the image panel; wherein the illuminating device comprises at least two light sources and at least two light guide plates transmitting light beams from the light sources to the image panel.

9. The illuminated logo unit of claim 8, wherein the light guide plates match with each other and transmit light beams from the light sources to the image panel by way of at least two illumination areas.

10. The illuminated logo unit of claim 9, wherein at least one of the light guide plates defines a hole, and another of the light guide plates is fitted into the hole.

11. The illuminated logo unit of claim 10, wherein the light guide plates are juxtaposed with each other.

12. The illuminated logo unit of claim 8, wherein each of the light guide plates comprises an emitting surface transmitting light beams to the image panel, and a peripheral sidewall adjoining the emitting surface.

13. The illuminated logo unit of claim 12, wherein the peripheral sidewall defines a groove accommodating a corresponding light source, wherein light beams are introduced into the light guide plate at the groove.

14. The illuminated logo unit of claim 13, wherein a reflective film is coated on the peripheral sidewall except at the groove.

15. The illuminated logo unit of claim 16, wherein the reflective film is made from a material having a high reflectivity.

16. The illuminated logo unit of claim 8, wherein the image panel is directly fixed on the illuminating device, or is clipped on the illuminating device.

17. The illuminated logo unit of claim 8, wherein each of the light sources is a point light source.

18. An illuminated logo unit An illuminated logo unit, comprising:
an image panel; and
an illuminating device located under the image panel for transmitting light beams to the image panel, and comprising a light source set and a light guide plate set for transmitting light beams from the light sources to the image panel; wherein
one of said light source set and said light plate set has more than one units while all the said light source set and said light plate set are arranged to be coplanar with each other.
